(19) United States
(12) Patent Application Publication
(10) Pub. No.: US 2026/0233472 A1
(43) Pub. Date: Aug. 13, 2026

(54) A METHOD OF ASSESSING THE IMPACT OF ULTRASONIC WELDING ON A PART DURING A PRE-PRODUCTION PROCESS AND AN APPARATUS FOR THE SAME

(71) Applicant: VODAFONE AUTOMOTIVE S.P.A, Varese (IT)

(72) Inventor: Maurizio MINGIONE, London (GB)

(21) Appl. No.: 19/155,973

(22) PCT Filed: Feb. 15, 2024
(86) PCT No.: PCT/EP2024/053916

§ 371 Date: Aug. 13, 2025

(30) Foreign Application Priority Data
Feb. 22, 2023 (IT) 102023000003024

(51) Int. Cl. B29C 65/82; B29C 65/08; B29C 65/78

(52) U.S. Cl. CPC B29C 65/8292; B29C 65/08; B29C 65/7841

(57) ABSTRACT

A method of assessing the impact of ultrasonic welding on a part during a pre-production process, the method including providing a device that includes a housing having an optically transparent window and a part supported therein, applying an ultrasonic welding process to the housing according to a set of input variables, each input variable being applied at a first initial value, and measuring the vibration of the part during the ultrasonic welding process through the window, using a non-contact measuring process.

This invention relates to a method of assessing the impact of ultrasonic welding on a part during a pre-production process, and an apparatus for assessing the impact of ultrasonic welding on a part during a pre-production process.

### BACKGROUND

Ultrasonic welding is a convenient way to seal a housing containing parts, such as electronic components. It is fast, economical, easily automated, and well suited for mass production. The high frequency vibrations during the ultrasonic welding process generates friction between abutting surfaces and the heat produced as a result of the vibrations causes the abutting surfaces to melt and, once the ultrasonic transceiver is switched off, the material solidifies and a weld is formed.

However, ultrasonic welding is not suitable for welding joints in close proximity to certain sensitive parts, as the vibrations applied to the housing surfaces are transmitted to parts contained within the housing and if the parts are sensitive to vibrations, the ultrasonic welding process can damage the parts. This renders ultrasonic welding unsuitable in a number of applications, such as for welding housings containing accelerometers that are commonly used in a number of electronics industries such as the automotive industry.

Furthermore, while parts are often provided with a technical data sheet, information provided on such data sheets are normally related to operational parameters which may be different to those the parts will be subjected to during the manufacturing process. Problems caused by using ultrasonic welding may therefore only become apparent during a final production process which can be costly to fix at such a late stage and may necessitate a redesign of the layout of the parts contained within the housing, adding further costs and delays to the manufacturing process.

The present invention seeks to address at least some of these issues.

### BRIEF SUMMARY OF THE DISCLOSURE

Viewed from a first aspect, the present disclosure provides a method of assessing the impact of ultrasonic welding on a part during a pre-production process. The method comprises providing a device comprising a housing having a window and a part supported therein, applying an ultrasonic welding process to the housing according to a set of input variables, each input variable being applied at a first test value, and measuring the vibration of the part during the ultrasonic welding process through the window using a non-contact measuring process.

This advantageously provides a pre-production development phase where the input variables can be optimised prior to a final production process, leading to acceptable levels of vibration of parts contained within the housing. This results in reduced component failure associated with vibration energy exceeding the ranges tolerated by the device components during the final production process or during downstream assembly processes where the device is incorporated into a larger system, for example a vehicle siren being incorporated into a vehicle assembly line.

The method may further comprise outputting a signal indicative of the measured vibration to a controller. The method may further comprise comparing, using the controller, the measured vibration with a pre-determined threshold to obtain a comparison result. The method may comprise outputting, using the controller, the comparison result.

The pre-determined threshold may comprise one or more vibration parameters of the part, for example an acceleration value. The one or more vibration parameters may be stored on a non-volatile memory of the controller. The controller may be configured to receive the one or more vibration parameters of the part from an external user. The method may comprise calculating an acceleration and/or velocity of the part from the measured vibration during the ultrasonic welding process. The method may comprise comparing the calculated acceleration and/or velocity with one or more vibration parameters of the part.

The method may further comprise determining, using the controller, a recommended value for each of the input variables based on the comparison result.

In some cases, at least one of the set of input variables can be applied at a second test value in the ultrasonic welding process. The method may comprise: applying the ultrasonic welding process to the housing according to the set of input variables when the at least one input variable is applied at the second test value, and measuring the vibration of the part during the ultrasonic welding process when the at least one input variable is applied at the second test value.

Determining, using the controller, the recommended value for each of the input variables may comprise: outputting, to the controller, a second signal indicative of the measured vibration of the part during the ultrasonic welding process when the at least one input variable is applied at the second test value, identifying, using the controller, a trend in the measured signals associated with the first test value of the at least one input variable and the second test value of the at least one input variable, and determining the recommended value for each of the set of input variables based on the identified trend The set of input variables may comprise any of: a welding frequency, an ultrasonic welding force, a welding amplitude and a shape of the housing.

The method may comprise providing a jig comprising a damper having a vibration absorption property to support the housing during the ultrasonic welding process. The set of input variables may comprise the vibration absorption property.

The set of input variables may be suitable for use in a final production process.

The part may be a substrate for supporting an electrical component, such as an accelerometer or a resistive sensor component. The substrate may be a printed circuit board.

The vibration of a portion of the substrate may be measured. The portion of the substrate may correspond to the position of the part or an electrical component or mechanical component to be mounted on the substrate during a final production process. In examples, the portion of the substrate measured may be the opposite side to which the part would be mounted. In some cases, the part comprises an electrical or mechanical component.

The housing may comprise a first portion and a second portion. The ultrasonic welding process may be for at least partially welding the first portion to the second portion, for example to seal the housing. The housing may comprise a plastic material.

The window may comprise an optically transparent element, for example an opening in the housing, such as a hole or a slot cut into the housing.

The vibration of the part may be measured using a laser, preferably a laser vibrometer. The measuring, using a non-contact measuring process may comprise: irradiating the part with a radiation source through the window and measuring a reflection of the radiation from the part through the window, and determining the vibration of the part based on the measured reflection. The radiation source may be arranged to irradiate the part directly. The radiation source may be arranged to irradiated the part indirectly. The apparatus may comprise one or more reflective elements such as a prism or mirror to direct the radiation towards the part. The radiation source may irradiate the part indirectly through the one or more reflective elements.

The part may comprise an accelerometer or a resistive sensor component. The device may comprise an automotive component, such as a vehicle siren.

There is also provided an apparatus for assessing the impact of ultrasonic welding on a device during a pre-production process, the apparatus comprising: an ultrasonic welding unit for applying an ultrasonic welding process to a device according to a set of input variables, each input variable being applied at a first test value. The device comprises a housing having a window and a part supported therein. The apparatus further comprises a measuring unit for measuring the vibration of the part in a non-contact manner through the window of the housing and a jig for supporting the device during the ultrasonic welding process, wherein the jig comprises a window through which the measuring unit can measure the vibration of the part during the ultrasonic welding process.

The jig may comprise a window alignable with the window of the housing. The window of the jig may be an opening in the jig, for example a hole or slot. The window may comprise an optically transparent portion, such as a hole or slot cut into the jig. The jig may comprise a removable portion having the window formed therein. This advantageously allows the same jig to be used with different devices that have a window in different positions. The removable portion may be a slidable or otherwise movable portion attachable to the jig. This advantageously allows a user to align the position of the window to suit a particular housing without having to replace parts of the jig.

The apparatus may comprise a radiation source, such as a laser, preferably a laser vibrometer, for measuring the vibration of the part. The apparatus may comprise a radiation source arranged to irradiate the part through the window of the housing, and a receiver arranged to measure a reflection of the radiation from the part through the window of the housing. The apparatus may comprise a controller configured to determine the vibration of the part based on the measured reflection. The apparatus may comprise a reflective element, such as a prism. The radiation source may be arranged to irradiate the part directly, or indirectly, for example through the reflective element. The radiation source may be arranged to irradiate the part through the window of the jig. The receiver may be arranged to measure the reflected radiation through the window of the jig.

The apparatus may comprise a controller operatively connected to the ultrasonic welding unit and configured to adjust one or more of the input variables during the ultrasonic welding process. The controller may be configured to receive and map the measured vibrations associated with each of the first value and the second value of the input variables.

The apparatus may comprise a controller configured to receive a signal indicative of the measured vibration. The controller may be configured to compare the measured vibration with a pre-determined threshold to determine a comparison result.

The pre-determined threshold may comprise one or more vibration parameters of the part. The controller may be configured to determine a recommended value for each of the set of input variables based on the comparison result.

At least one of the set of input variables can be applied at a second test value in the ultrasonic welding process. The apparatus may comprise a controller operatively connected to the ultrasonic welding unit and configured to: apply the ultrasonic welding process to the housing according to the set of input variables when the at least one input variable is applied at the second test value, and measure the vibration of the part during the ultrasonic welding process when the at least one input variable is applied at the second test value.

The controller may be configured to receive a second signal indicative of the measured vibration of the part during the ultrasonic welding process when the at least one input variable is applied at the second test value, identify a trend in the measured signals associated with the first test value of the at least one input variable and the second test value of the at least one input variable, and determine the recommended value for each of the set of input variables based on the identified trend.

The set of input variables may comprise any of: a welding frequency, an ultrasonic welding force, a welding amplitude, and a shape of the housing.

The jig may comprise a resiliently deformable damper having a vibration absorption property for supporting the device during the ultrasonic welding process. The set of input variables may comprise the vibration absorption property.

The controller may be configured to calculate an acceleration and/or velocity of the part from the measured vibration during the ultrasonic welding process.

### BRIEF DESCRIPTION OF THE DRAWINGS

Embodiments of the invention are further described hereinafter with reference to the accompanying drawings, in which:

FIGS. 1A & 1B are schematic representations of exemplary apparatus suitable for implementing the methods described herein;

FIG. 2 is a schematic illustration of an exemplary process, and

FIG. 3 illustrates a schematic illustration of an exemplary apparatus used in a final production process.

### DETAILED DESCRIPTION

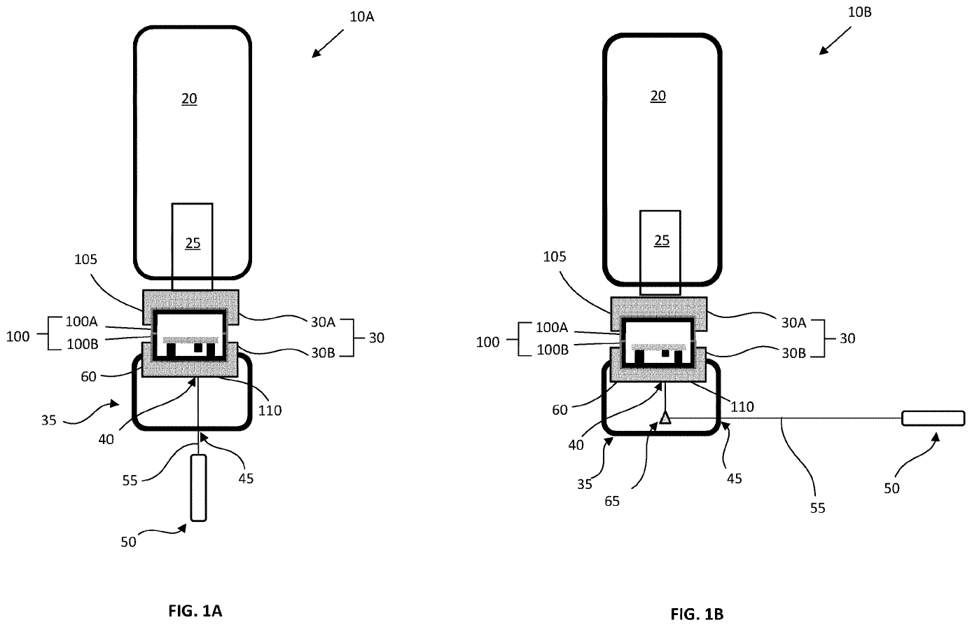

FIGS. 1A & 1B illustrate exemplary apparatus 10A, 10B for assessing the impact of ultrasonic welding on parts 115 that are, or could potentially be, contained within a housing 100 (see also FIG. 3). In the subsequent description, like elements are denoted by the same reference numerals.

The apparatus 10A includes an ultrasonic welding unit 20, a jig 35 for supporting a device having a housing 100, and a laser vibrometer 50. The ultrasonic welding unit 20 has a horn 25 for transferring the ultrasonic vibrations to the housing 100, specifically to the upper housing portion 100A as shown in FIG. 1A. A holder 30 including upper 30A and lower 30B portions is used to hold the device in position during the ultrasonic welding process. The lower holder portion 30B can include one or more absorption systems (such as a damper) to at least partially support the device within the jig 35 and to reduce the accelerations applied to the device. A lower housing portion 100B supports a printed circuit board 105 in FIG. 1A. However, it would be apparent that a printed circuit board 105 was merely one example of an electronic component and that other parts, for example other electronic or mechanical components, could be supported in the housing 100. The part can be an accelerometer, for example as used in a vehicle siren or other automotive component, and/or a resistive sensor component.

The lower housing portion 100B includes a hole 110 which is aligned with a corresponding hole 40 in the lower portion 30B of the jig 35. The hole 40 provides an optically transparent window for the laser vibrometer 50 to illuminate the printed circuit board 105 at a pre-determined position 60. By monitoring the vibrations at one or more pre-determined positions 60 on the printed circuit board 105, such as where parts 115 susceptible to damage from high frequency vibrations will be placed in a final production process, the input variables used to control the ultrasonic welding process can be tuned to reduce the risk of damage to particular parts 115, rather than having to reduce the overall vibrations applied to the whole housing 100 which may impose unnecessary limitations on the housing 100 and/or compromise the quality of the weld.

In one example, a laser vibrometer 50 is used to measure the vibration of the pre-determined position 60 of the printed circuit board 105 using the reflected laser beam from the surface of the printed circuit board 105. While the instantaneous measurement from a laser vibrometer includes velocity of the pre-determined position 60 due to the Doppler shift, the signal itself is characterised by several aspects of the vibrating printed circuit board 105, such as the vibration amplitude, frequency and/or phase of the pre-determined position 60. It is possible to derive vibration parameters that can be used to assess whether the particular combination of welding input variables would damage the part 115. For example, the signal from the laser vibrometer can be demodulated to derive the velocity and acceleration of the pre-determined position 60. Any of these data can be used in the comparison to determine whether there is a risk of damaging sensitive parts 115 during the final manufacturing process, and if so, how the input variables for the ultrasonic welding process should be adjusted to minimise this risk. A laser vibrometer 50 is one example of a radiation source suitable for irradiating the part 115 (if present) or a portion of the printed circuit board 105. By measuring the radiation reflected from the part 115 or portion of the printed circuit board 105, it is possible to determine the vibration of the part 115 or potion of the printed circuit board 105.

While FIG. 1A shows the laser beam 55 being emitted directly onto the printed circuit board 105, this is not essential and in some cases the laser beam 55 can be emitted indirectly onto the printed circuit board 105. By way of example, this can be achieved using the apparatus shown in FIG. 1B, which includes a prism 65 arranged to redirect the incident laser beam 55 onto the printed circuit board 105 at the pre-determined position 60. While a prism 65 is disclosed, it would be apparent this was merely an example of a reflective element suitable for redirecting the laser beam 55 and that mirrors or similar reflective elements may be used. Apparatus 10A and 10B both include a further hole 45 in the jig 35 to allow the laser beam 55 to enter the jig 35 before passing through a separate hole 40 in the lower holder 30B. However, it would be apparent this was not essential and in some cases, the laser vibrometer 50 may be provided within the jig 35, thus removing the need for an additional hole 45 to receive the laser beam 55 from the laser vibrometer 50.

While holes 40, 45 110 are described, it would be apparent that other openings (e.g. slots or similar) or similar optically transparent elements may be provided in the lower portion 30B and/or lower housing portion 100B and/or jig 35 in place of holes 40, 45, 110 to allow the laser beam 55 to illuminate the printed circuit board 105.

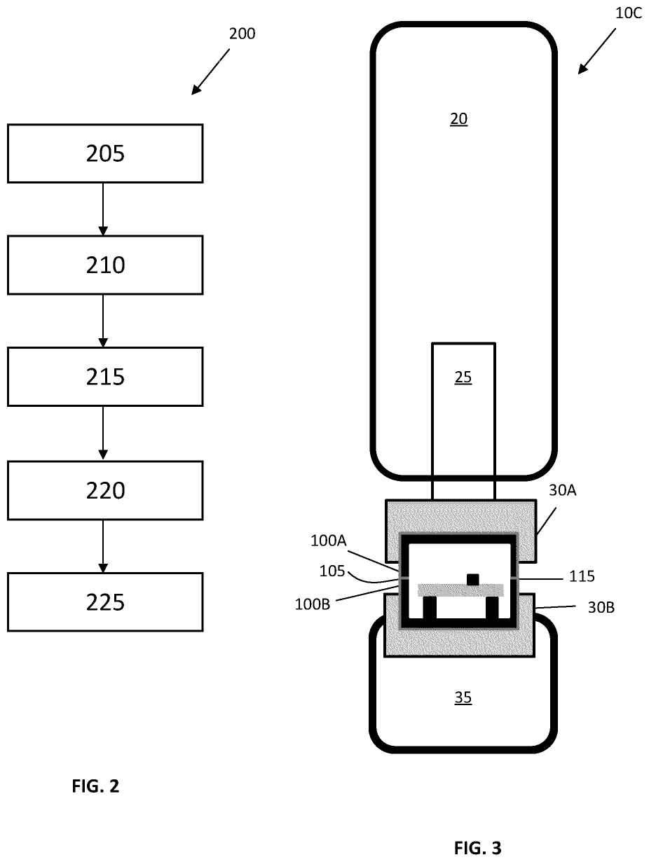

FIG. 2 illustrates an exemplary process 200. One or more steps may be omitted from the production process 200, for example a pre-production process, or added to the process 200 as described below.

To determine whether a set of input variables are suitable for a final production process, a device is first mounted 205 to the apparatus 10A, 10B. A set of input variables are applied 210 to the housing portions 100A, 100B for welding the housing portions 100A, 100B together. It would be apparent that each of the input variables would be applied at a first value initially. As the ultrasonic welding process takes place, the vibrations applied to the printed circuit board 105 are measured using the laser vibrometer 50 as described above. It would be apparent that the laser vibrometer 50 may measure vibrations for a portion of the ultrasonic welding process 210 or for the entirety of the ultrasonic welding process 210. Similarly, it is not essential to weld the housing portions 100A, 100B together, as sufficient data may be captured from the welding process in a time shorter than is necessary to completely weld the housing portions 100A, 100B together.

The measured 215 vibration data is then compared 220 against a vibration resistance specification of one or more parts 115 that are, or will be, mounted to the printed circuit board 105 in the final production process. The vibration resistance specification can be determined prior to applying 210 the ultrasonic welding process according to the set of input variables. For example, one or more acceptable limits of the vibration resistance specification may be derived from the technical specification associated with the device. The vibration resistance specification will depend on the specific parts 115 included in the device, but can for example be an upper limit of between 1,000 g to 10,000 g which are typical accelerations the part would be exposed to during the ultrasonic welding process.

It would be apparent that multiple positions 60 on the printed circuit board 105 could be measured during the ultrasonic welding process and that these positions may correspond to the position of one or more electrical components or parts which will be mounted to the printed circuit board in the final production process. If multiple parts are, or will be, present on the device, the part most susceptible to being damaged during the ultrasonic welding process can be identified prior to inserting 205 the device into the apparatus 10A, 10B (for example the part with the least tolerance to sustained accelerations). Parts more susceptible to damage during the ultrasonic welding process include, but are not limited to, those with moving structures therein, as is the case in accelerometers. Alternatively or additionally, one or more operating parameters (e.g. a maximum acceleration or vibration frequency) related to the part can be taken from a technical specification for the part to set the vibration threshold.

While the present application describes welding two housing portions 100A, 100B together, it would be apparent that the present method and apparatus can be used in any ultrasonic welding process where two items are welded together. These two items need not be housing portions 100A, 100B specifically. Similarly, while the horn 25 applies the ultrasonic welding process to the upper jig portion 30A, it would be apparent this was merely exemplary, and other arrangements of housing 100 and jig 30 are envisaged and the horn 25 may be in contact with the lower holder portion 30B.

While FIGS. 1A and 1B show the printed circuit board 105 free of any parts 115 mounted thereon, it would be apparent this was not essential and one or more parts 115 to be used in the final device could be included on the printed circuit board 105 as part of the pre-production assessment of the impact of the ultrasonic welding process. This may be particularly relevant where the part 115 may influence the vibration characteristics of the printed circuit board 105. Furthermore, the vibration resistance specification is merely one example of a pre-determined threshold above which the level of vibrations may be considered unacceptable. Following the comparison 220 of the measured vibrations to the vibration resistance specification, one or more recommended values for each of the set of input variables can be determined 225 to reduce the level of vibrations applied to the printed circuit board 105. This may be the case where the initial values used for each input variable result in acceptable levels of vibration of the pre-determined position 60. In this case, there may not be any need for further optimisation of the ultrasonic welding process and these values can be used in the final production process knowing that the parts 115 will not be damaged using the validated input variable values.

The set of input variables includes any of a welding frequency, a welding force, a welding amplitude of the horn 25, a parameter associated with a damper system present in the jig 35 for supporting the device and a welding energy associated with the welding process according to the set of input variables. By adjusting one or more values associated with each of the input variables and measuring the resulting vibrations of the pre-determined position 60 on the printed circuit board 105, it is possible to identify acceptable input variable values (e.g. those that do not exceed a pre-predetermined level of acceleration) as candidates for the final production process. For example, for a given device with a housing having a particular shape, the welding frequency can be adjusted from 20 kHz to 30 kHz in one or more pre-determined increments, while keeping the remaining input variables fixed to identify acceptable welding frequencies. This process can be repeated for any remaining adjustable input variables in order to map the effect of each input variable on the acceleration of the pre-determined position 60. For example, the welding force can be adjusted between 300 to 500 N in pre-determined increments, the horn amplitude can be adjusted between 50 μm to 100 μm in pre-determined increments, and the damping characteristics of different damper systems optionally present in the jig 35 can be varied in a similar manner. By mapping the effect different combinations of input variables have on the resultant vibrations of the pre-determined position 60 and comparing the corresponding accelerations measured by the laser vibrometer 50 to acceptable thresholds for a given device or part 115 of the device, a range of recommended values for each input variable can be determined 220 for the final production process. It would be apparent the specific values of input variables provided herein are merely exemplary and other ultrasonic welding units 20 will be operable with different values of input variables.

The recommended values for each input variable may be determined 220 based on the shape of the housing 100 and/or holder 30 and/or any damper arrangements provided between the holder 30 and the housing 100 as these factors can also influence the level of vibrations applied to the printed circuit board 105. Steps 210 to 225 can be repeated to validate the reduction in vibration levels using the second, or further iterated, values for each input variable. For example, the input variables can be adjusted in a first incremental step that is relatively large in order to provide an initial indication of suitable values for each input variable. Based on the measured accelerations associated with one or more sets of input variable values being acceptable (i.e. below the pre-determined threshold), the process can repeated with a second incremental step that is smaller than the first incremental step to identify optimal values for each input variable. Once the input variables have been optimised such that the vibrations of the printed circuit board 105 are reduced to an acceptable level, the optimised values for each input variable can be recommended for use in a final production process to produce the final devices.

While sequentially adjusting each input variable is described, it would be apparent a controller operatively coupled to the laser vibrometer 50 and the ultrasonic welding unit 20 may identify trends in the signals associated with the vibration measurements of the pre-determined position 60 and select the next value of input variable to test. For example, the controller can identify that increasing ultrasonic welding frequency is resulting in increasing accelerations of the pre-determined position 60, for example trending away from the acceptable threshold, and can recommend a lower ultrasonic welding frequency as the next value to test. This would allow for automated identification of optimal values for each input variable for a given device.

Any of the input variables used to operate an ultrasonic welding unit 20 may be adjusted based on the measured data. These include, but are not limited to, the force the horn 25 applies to the upper holder 30A, the amplitude the horn 25 vibrates at, the frequency the horn 25 vibrates at, the distance target of the ultrasonic welding unit 20, the time target of the ultrasonic welding unit 20 and the weld energy of the ultrasonic welding process, a vibration damping characteristic of any dampers provided between the holder 30 and the housing 100. Quantifying the vibration of the pre-determined position 60 in the described manner provides a method of validating the parts 115 will not be damaged during the final production process. In turn, this leads to reduced rates of part failure during the manufacturing process, and in turn alleviates the burden on downstream assembly processes which may inadvertently install a defective device and subsequently have to replace the device, incurring additional time and cost in the manufacturing process.

FIG. 3 illustrates an exemplary apparatus 10C for use in a final production process. Like elements of apparatus 10C are denoted by the same reference numerals used in relation to apparatus 10A and 10B and the description related to those elements apply equally to apparatus 10C. The difference between apparatus 10C and apparatus 10A and 10B is there is no hole provided in any of the jig 35, the lower holder 30B and the lower housing portion 100B, as the laser vibrometer 50 is not typically part of the final production process. In some cases, the final production process may take place at a different site to where the pre-production process is preformed to optimise the input variables, and involve different apparatus. It would be apparent that in some cases, the apparatus illustrated in FIG. 1A or 1B may be used in the final production process in addition to the pre-production process.

By way of example, the device can be an automotive component, such as a vehicle siren, which includes an accelerometer. An accelerometer contains moving parts and is particularly sensitive to the high frequency vibrations generated during the ultrasonic welding process, and so the pre-production process described herein to optimise the input variables to reduce the levels of vibration experienced by the accelerometer to an acceptable level during the ultrasonic welding process that is used to manufacture the final product. This advantageously enables the vehicle siren housing to be welded using ultrasonic welding which would otherwise not be possible as the accelerometer could potentially be damaged without optimisation of the process. The present methods and apparatus also advantageously increase the reliability of parts produced in the final manufacturing process as the input variables defining the ultrasonic welding process will result in an acceptable level of vibration of the printed circuit board 105, and consequently of the parts 115 mounted thereto.

While automotive components are described as one exemplary use-case, it would be apparent the present methods and apparatus could be used to optimise the input variables used to seal any device housing.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A method of assessing an impact of ultrasonic welding on a part during a pre-production process, the method comprising:
providing a device comprising a housing having a window and a part supported therein,
applying an ultrasonic welding process to the housing according to a set of input variables, each input variable being applied at a first test value, and
measuring a vibration of the part during the ultrasonic welding process through the window using a non-contact measuring process.

2. The method of claim 1, wherein the method further comprises:
outputting a first signal indicative of the measured vibration to a controller, and comparing, using the controller, the measured vibration with a pre-determined threshold to obtain a comparison result.

3. The method of claim 2, wherein the pre-determined threshold comprises one or more vibration parameters of the part.

4. The method of claim 2, wherein the method further comprises:
determining, using the controller, a recommended value for each of the set of input variables based on the comparison result.

5. The method of claim 4, wherein at least one of the set of input variables can be applied at a second test value in the ultrasonic welding process, and wherein the method comprises:
applying the ultrasonic welding process to the housing according to the set of input variables when the at least one of the set of input variables is applied at the second test value, and
measuring the vibration of the part during the ultrasonic welding process when the at least one of the set of input variables is applied at the second test value.

6. The method of claim 5, wherein determining, using the controller, the recommended value for each of the set of input variables comprises:
outputting, to the controller, a second signal indicative of the measured vibration of the part during the ultrasonic welding process when the at least one of the set of input variables is applied at the second test value,
identifying, using the controller, a trend in the first signal and the second signal that were measured and associated with the first test value of the at least one of the set of input variables and the second test value of the at least one of the set of input variables, and
determining the recommended value for each of the set of input variables based on the trend that was identified.

7. The method of claim 1, wherein the set of input variables comprises any of: a welding frequency, an ultrasonic welding force, a welding amplitude, and/or a shape of the housing.

8. The method of claim 1, further comprising:
providing a jig comprising a damper having a vibration absorption property to support the housing during the ultrasonic welding process,
wherein the set of input variables comprises the vibration absorption property.

9. The method of claim 1, further comprising:
calculating an acceleration and/or a velocity of the part from the measured vibration during the ultrasonic welding process.

10. The method of claim 1, wherein the part comprises a substrate for supporting an electrical component.

11. The method of claim 1, wherein the housing comprises a first portion and a second portion, and
wherein the ultrasonic welding process is for at least partially welding the first portion to the second portion.

12. The method of claim 1, wherein the window comprises an optically transparent element, and
wherein the part comprises an accelerometer or a resistive sensor component.

13. The method of claim 1, wherein the measuring, using the non-contact measuring process comprises:
irradiating the part with a radiation source through the window and measuring a reflection of radiation from the part through the window, and
determining the vibration of the part based on the measured reflection.

14. (canceled)

15. An apparatus for assessing an impact of ultrasonic welding on a device during a pre-production process, the apparatus comprising:
an ultrasonic welding unit for applying an ultrasonic welding process to the device according to a set of input variables, each input variable being applied at a first test value, the device comprising a housing having a window and a part supported therein,
a measuring unit for measuring a vibration of the part in a non-contact manner through the window of the housing, and
a jig for supporting the device during the ultrasonic welding process,
wherein the jig comprises a window through which the measuring unit can measure the vibration of the part during the ultrasonic welding process.

16. The apparatus of claim 15, wherein the apparatus further comprises:
a radiation source arranged to irradiate the part through the window, and a receiver arranged to measure a reflection of radiation from the part through the window,
wherein the apparatus comprises a controller configured to determine the vibration of the part based on the measured reflection.

17. The apparatus of claim 15, wherein the apparatus comprises a controller configured to receive a first signal indicative of the measured vibration, and compare the measured vibration with a pre-determined threshold to determine a comparison result, and
wherein the pre-determined threshold comprises one or more vibration parameters of the part.

18. (canceled)

19. (canceled)

20. The apparatus of claim 17,
wherein the controller is further configured to determine a recommended value for each of the set of input variables based on the comparison result,
wherein at least one of the set of input variables can be applied at a second test value in the ultrasonic welding process, and
wherein the apparatus comprises the controller operatively connected to the ultrasonic welding unit and configured to:
apply the ultrasonic welding process to the housing according to the set of input variables when the at least one of the set of input variables is applied at the second test value, and
measure the vibration of the part during the ultrasonic welding process when the at least one of the set of input variables is applied at the second test value.

21. The apparatus of claim 20, wherein the controller is further configured to:
receive a second signal indicative of the measured vibration of the part during the ultrasonic welding process when the at least one of the set of input variables is applied at the second test value,
identify a trend in the first signal and the second signal that were measured that are associated with the first test value of the at least one of the set of input variables and the second test value of the at least one of the set of input variables, and
determine the recommended value for each of the set of input variables based on the trend that was identified.

22. The apparatus of claim 16, wherein the set of input variables comprises any of: a welding frequency, an ultrasonic welding force, a welding amplitude, and/or a shape of the housing, and
wherein the controller is configured to calculate an acceleration and/or velocity of the part from the measured vibration during the ultrasonic welding process.

23. The apparatus of claim 15, wherein the jig comprises a resiliently deformable damper having a vibration absorption property for supporting the device during the ultrasonic welding process, and
wherein the set of input variables comprises the vibration absorption property.

24. (canceled)
